(19) United States
(12) Patent Application Publication
(10) Pub. No.: US 2023/0408312 A1
(43) Pub. Date: Dec. 21, 2023

(54) METHOD FOR ASCERTAINING A FLUID PRESSURE IN A FLUID SUPPLY NETWORK FOR FLUID AND ULTRASONIC FLUID METERS, AND ULTRASONIC FLUID METER

(71) Applicant: Diehl Metering GmbH, Ansbach (DE)

(72) Inventors: Philip Wolf, Ansbach (DE); Alexander Hofmann, Sachsen (DE); Florian Herrmann, Dinkelsbühl (DE); Steffen Ritter, Bechhofen (DE)

(21) Appl. No.: 18/333,147

(22) Filed: Jun. 12, 2023

(30) Foreign Application Priority Data
Jun. 15, 2022 (DE) 10 2022 115 042.9

(51) Int. Cl. G01F 1/667; G01F 15/02; G01F 15/14; G01F 1/66

(52) U.S. Cl. CPC G01F 1/667; G01F 15/02; G01F 15/14; G01F 1/662

(57) ABSTRACT

A method for ascertaining fluid pressure in a fluid supply network having ultrasound transducers includes emitting an ultrasound signal from at least one ultrasound transducer and measuring at least one ultrasound time of flight of the signal in the fluid along an ultrasound measurement path. The flow velocity or a quantity proportional thereto or throughput is determined from the time of flight. The fluid pressure is determined from the time of flight aided by a mathematical compensation relating to at least one influence selected from a length or length change of the measurement path or a time of flight component or change thereof along the measurement path lying in or not lying in the fluid, or a fastening or position of the ultrasound transducer relative to the measurement path or a change thereof or a latency of signal processing or a change thereof or a throughput or change thereof.

### CROSS-REFERENCE TO RELATED APPLICATION

This application claims the priority, under 35 U.S.C. § 119, of German Patent Application DE 10 2022 115 042.9, filed Jun. 15, 2022; the prior application is herewith incorporated by reference in its entirety.

### FIELD AND BACKGROUND OF THE INVENTION

The present invention relates to a method for ascertaining a fluid pressure in a fluid supply network for fluid, having a first ultrasound transducer and a second ultrasound transducer, in which at least one ultrasound signal is emitted by at least one ultrasound transducer and at least one ultrasound time of flight of the ultrasound signal in the fluid is measured along an ultrasound measurement path, the flow velocity or a quantity proportional to the flow velocity, in particular the throughput, is determined from the at least one measured ultrasound time of flight. The invention also relates to an ultrasonic fluid meter for installation in a fluid supply network, including a connection housing with an inlet and an outlet, at least one ultrasound measurement path, which is provided in the connection housing and along which at least one ultrasound time of flight of an ultrasound signal propagating along the ultrasound measurement path in the fluid is measured, at least a first and a second ultrasound transducer, the respective first or second ultrasound transducer respectively receiving or emitting the ultrasound signal propagating along the ultrasound measurement path, and a control and calculation unit.

Ultrasonic fluid meters are conventionally used to ascertain consumption quantities of fluid in a fluid supply network. The fluid supply network may be formed of a multiplicity of pipeline systems. Ultrasonic fluid meters are generally used for determining the throughput, volume or amount of heat and/or for determining the pressure of fluids, for example water.

The most common application field of ultrasonic fluid meters involves water meters for ascertaining the drinking water consumption in buildings and households as well as heat meters for ascertaining the heat energy consumed. Ultrasonic fluid meters generally have a connection housing with an inlet and outlet. Through the use of the connection housing, the ultrasonic fluid meter can be installed in a pipeline system of a fluid supply network, for example a drinking water supply. The flow direction of the fluid inside the ultrasonic fluid meter may remain unchanged from the inlet to the outlet or, depending on the configuration of the ultrasonic fluid meter, it may also change. Besides determining the flow velocity, or a throughput derived therefrom, ultrasonic fluid meters may also be used to ascertain the fluid pressure.

The functionality of an ultrasonic fluid meter is based on the use of ultrasound transducers, in particular piezoelectric-based ultrasound transducers, which are fitted in the region of the connection housing of the ultrasonic fluid meter. In that case, two ultrasound transducers always form an ultrasound transducer pair, an ultrasound measurement path being located between the two ultrasound transducers of the ultrasound transducer pair. Ultrasound signals, so-called ultrasound bursts, which are transmitted and received by the ultrasound transducers, propagate along the ultrasound measurement path.

The throughput and/or volume determination by using an ultrasonic meter of a medium flowing through may be carried out with the aid of a time-of-flight difference measurement of the ultrasound signals. The time-of-flight difference is determined by initially transmitting an ultrasound signal from a first ultrasound transducer to a second ultrasound transducer along the ultrasound measurement path, for example obliquely in the flow direction. Subsequently, an ultrasound signal is transmitted by the second ultrasound transducer in the opposite direction along the ultrasound measurement path, for example likewise obliquely with respect to the flow direction, to the first ultrasound transducer. The transmission of the ultrasound signal from one ultrasound transducer to the other ultrasound transducer along the ultrasound measurement path takes place more rapidly in the flow direction of the medium than against the flow direction of the medium. This time difference of the transmission durations of the two ultrasound signals is referred to as the time-of-flight difference of the ultrasound signals. With the aid of this time-of-flight difference and the dimension of the ultrasonic fluid meter or of the ultrasound measurement path, which is known in advance, the throughput or the volume of the medium flowing through can be determined independently of the speed of sound in the medium.

If the flow velocity is known or has been determined in the manner described above, the ultrasound speed in the fluid may also be ascertained with the aid of the individual ultrasound times of flight or a summation. It is dependent on the temperature and the fluid pressure. If the temperature is known and/or constant, or if the temperature is measured, with a known ultrasound speed it is therefore possible to determine the fluid pressure. Yet since the ultrasound speed changes only slightly in the event of a pressure change, even small measurement deviations in the measurement of the ultrasound time of flight, or of the ultrasound times of flight, lead to large deviations in the pressure determination.

German Patent Application DE 10 2012 022 376 A1 discloses a method for determining the pressure of a fluid in a container, wherein a property of the fluid, or of an element in the container that is exposed to the pressure of the fluid, that property being influenced by the pressure of the fluid, is ascertained by using an acoustic wave in the fluid and wherein the pressure is determined from the ascertained property. A correction of measurement deviations is not disclosed, so that the fluid pressure can only be determined with restricted accuracy.

### SUMMARY OF THE INVENTION

It is accordingly an object of the invention to provide a method for ascertaining a fluid pressure in a fluid supply network for fluid and ultrasonic fluid meters, and an ultrasonic fluid meter, which overcome the hereinafore-mentioned disadvantages of the heretofore-known methods and meters of this general type and in which a fluid pressure is determined with the aid of a compensation. The accuracy of the pressure determination is thereby intended to be increased.

The aforementioned object is achieved by the entire teaching of the independent claims. Expedient configurations of the invention are claimed in the dependent claims.

With the foregoing and other objects in view there is provided, in accordance with the invention, a method for ascertaining a fluid pressure in a fluid supply network for fluid, having a first ultrasound transducer and a second ultrasound transducer, in which:
at least one ultrasound signal is emitted by at least one ultrasound transducer and at least one ultrasound time of flight of the ultrasound signal in the fluid is measured along an ultrasound measurement path,
the flow velocity or a quantity proportional to the flow velocity, in particular the throughput, is determined from the at least one measured ultrasound time of flight,
the fluid pressure is determined from the at least one measured ultrasound time of flight with the aid of a mathematical compensation,
the mathematical compensation relating to at least one influence from the following group of influences:
   a length of the ultrasound measurement path or length change thereof,
   an ultrasound time-of-flight component along the ultrasound measurement path, which does not lie in the fluid, or a change thereof,
   an ultrasound time-of-flight component within the ultrasound measurement path, which lies in the fluid, or a change thereof,
   a fastening and/or position of the ultrasound transducer with respect to the ultrasound measurement path or a change thereof,
   a latency of the signal processing or a change thereof and/or
   a throughput or a change thereof.

One particular advantage of the invention is that the fluid pressure can be determined substantially more accurately by the mathematical compensation.

Expediently, an ultrasound signal may be emitted by the first ultrasound transducer and received by the second ultrasound transducer, the ultrasound time of flight being determined. An ultrasound signal may be emitted by the second ultrasound transducer and received by the first ultrasound transducer, the ultrasound time of flight likewise being determined. The flow velocity and/or a quantity proportional to the flow velocity, in particular a throughput, may be determined from the measured ultrasound times of flight and/or from the difference of the measured ultrasound times of flight and/or the difference of the inverses of the measured ultrasound times of flight. Advantageously, taking the difference of the measured ultrasound times of flight and/or the difference of the inverses of the measured ultrasound times of flight allows determination, independent of the ultrasound speed, of the flow velocity or a quantity proportional to the flow velocity, in particular the throughput.

Furthermore, with the aid of a mathematical compensation, the fluid pressure may be ascertained from the measured ultrasound times of flight and/or from a time-of-flight difference of the measured ultrasound times of flight and/or from a difference of the inverses of the measured ultrasound times of flight and/or from a time-of-flight sum of the measured ultrasound times of flight and/or from a sum of the inverses of the measured ultrasound times of flight and/or from an average value of the measured ultrasound times of flight. Advantageously, the ultrasound speed may be ascertained by using the sum of the measured ultrasound times of flight and/or the sum of the inverses of the measured ultrasound times of flight or by using the average value of the measured ultrasound times of flight, independently of the flow velocity or a quantity proportional to the flow velocity, in particular the throughput.

Furthermore, the ultrasound measurement path may be disposed obliquely at an angle with respect to the flow direction of the fluid and/or may be deviated one or more times by using reflectors.

Advantageously, a temperature or a temperature change, in particular a temperature change of the temperature from a reference temperature, may be measured or determined and used for the mathematical compensation.

Furthermore, this temperature may be the temperature of the fluid and/or the temperature change may be the temperature change of the fluid.

Expediently, a connection housing having compartments for the ultrasound transducers may be provided and/or the ultrasound transducers may respectively have an ultrasound transducer housing respectively having a wall with a thickness, through which at least one ultrasound signal passes.

The mathematical compensation may be carried out exclusively on the basis of mathematical calculations.

Furthermore, the mathematical compensation may have at least one input variable and at least one output variable, the at least one output variable being calculated with the aid of a function from the at least one input variable.

In one advantageous configuration, the at least one output variable of the mathematical compensation may be calculated independently of reference measurements and/or independently of characteristic diagram determinations.

Furthermore, the at least one input variable may be based on a characteristic diagram and/or a characteristic curve and/or a measurement value and/or empirical data and/or a comparative measurement and/or a calibration.

The at least one output variable may also be based on at least one geometrical relationship, in particular at least one trigonometric relationship, and/or at least one linear relationship and/or at least one nonlinear relationship and/or at least one material constant and/or at least one physical constant and/or at least one algorithm and/or at least one analytical or numerical calculation and/or at least one numerical simulation.

Advantageously, the mathematical compensation may relate to at
least one effect selected from the following group of effects:
a thickness of at least one wall,
a thickness change of at least one wall,
an ultrasound speed of at least one wall,
an ultrasound speed change of at least one wall,
an ultrasound speed of the fluid,
an ultrasound speed change of the fluid
the flow velocity,
a length or length change of the ultrasound measurement path due to a thermal expansion, preferably of the connection housing, on the basis of a temperature or a temperature change, in which case the temperature or the temperature change of the connection housing may preferably correspond to the temperature or the temperature change of the fluid,
a tilt of an ultrasound transducer by an angle with respect to the ultrasound measurement path,
an angle change of the angle,
a position of at least one ultrasound transducer in the direction of the ultrasound measurement path,
a position change of at least one ultrasound transducer in the direction of the ultrasound measurement path,
a position of at least one ultrasound transducer transversely with respect to the ultrasound measurement path and along a plane which is formed by the ultrasound measurement path and the axis of the connection housing,
a position change of at least one ultrasound transducer transversely with respect to the ultrasound measurement path and along a plane which is formed by the ultrasound measurement path and the axis of the connection housing,
a position of at least one ultrasound transducer transversely with respect to the ultrasound measurement path and transversely with respect to the axis of the connection housing,
a position change of at least one ultrasound transducer transversely with respect to the ultrasound measurement path and transversely with respect to the axis of the connection housing,
a time-of-flight component due to the throughput and/or
a time-of-flight component change due to the throughput.

Expediently, the latency of the signal processing or a change thereof may be compensated by taking the difference of at least one measured ultrasound time of flight and at least one latency component.

For example, the at least one latency component may be determined from the time offset between a transmission signal and the transmitted ultrasound signal and/or the time offset between a reception signal and the received ultrasound signal.

Furthermore, the length of the ultrasound measurement path and/or a length change of the ultrasound measurement path and/or the angle and/or an angle change of the ultrasound measurement path may be determined on the basis of a position and/or a position change and/or the angle and/or the angle change of an ultrasound transducer.

In another configuration, a fluid pressure may be ascertained from a look-up table and/or a characteristic diagram and/or a reference measurement and/or a calibration, the ascertained fluid pressure being employed as the at least one input variable for the determination of the fluid pressure.

With the objects of the invention in view, there is also provided an ultrasonic fluid meter for installation in a fluid supply network, comprising a connection housing with an inlet and an outlet, at least one ultrasound measurement path, which is provided in the connection housing and along which at least one ultrasound time of flight of an ultrasound signal propagating along the ultrasound measurement path in the fluid is measured, at least a first and a second ultrasound transducer, the respective first or second ultrasound transducer respectively receiving or emitting the ultrasound signal propagating along the ultrasound measurement path, and a control and calculation unit. The control and calculation unit is configured to carry out the method for determining the fluid pressure. The control and calculation unit may also be configured to forward data, in particular the measured ultrasound time of flight, to a head end, the head end being configured to carry out the method for determining the fluid pressure.

In the ultrasonic fluid meter, the ultrasound measurement path may be disposed at a preferably acute angle with respect to the axis of the connection housing.

A temperature sensor for recording the temperature of the fluid may furthermore be provided.

The ultrasound transducers may be mounted in compartments in the connection housing.

In one configuration, a multiplicity of ultrasound measurement paths may be provided and a multiplicity of measured ultrasound times of flight and/or pressures and/or flow velocities and/or quantities proportional to the flow velocity, in particular throughputs, may be determined.

The ultrasound measurement paths, in relation to the cross section of the connection housing, may be disposed at an angle with respect to one another and intersect.

A centerweighted determination of the pressures and/or flow velocities and/or of the quantities proportional to the flow velocity, in particular the throughputs, may be carried out.

Furthermore, a weighted average value, preferably an equally weighted average value, of the measured ultrasound times of flight and/or a weighted average value, preferably an equally weighted average value, of the pressures and/or a weighted average value, preferably an equally weighted average value, of the flow velocities and/or of the quantities proportional to the flow velocity, in particular the throughputs, may be determined.

Other features which are considered as characteristic for the invention are set forth in the appended claims.

Although the invention is illustrated and described herein as embodied in a method for ascertaining a fluid pressure in a fluid supply network for fluid and ultrasonic fluid meters, and an ultrasonic fluid meter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a simplified, diagrammatic, longitudinal-sectional view of an example of an ultrasonic fluid meter;

FIG. 2 is an enlarged, simplified, partial longitudinal-sectional view of the example according to FIG. 1 of an ultrasound transducer of the ultrasonic fluid meter;

FIG. 3 is a highly simplified, schematic block diagram of a control and calculation unit of an ultrasonic fluid meter;

FIG. 4 is a schematic flow chart of an example of a method for ascertaining the fluid pressure according to the present invention;

FIG. 5 is a schematic flow chart of an example of a method for ascertaining the fluid pressure according to FIG. 4 for various influences according to the present invention; and

FIG. 6 is a simplified cross-sectional view of the example of an ultrasonic fluid meter according to FIG. 1.

### DETAILED DESCRIPTION OF THE INVENTION

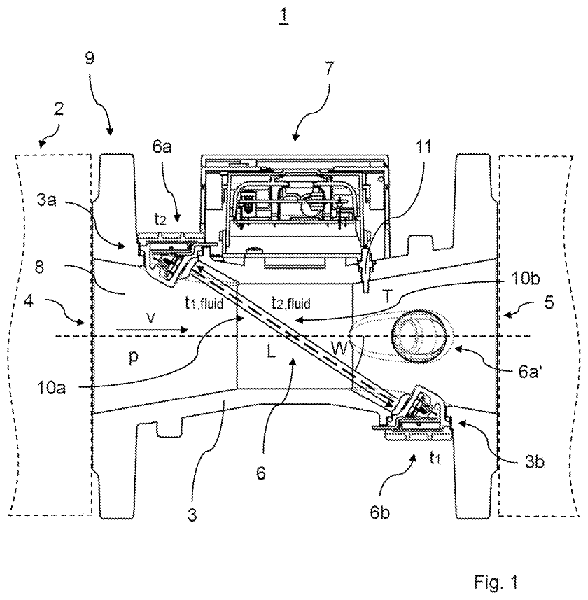

Referring now to the figures of the drawings in detail and first, particularly, to FIG. 1 thereof, there is seen an ultrasonic fluid meter 1 for ascertaining the fluid pressure p and the flow velocity v of a fluid 8 in a fluid supply network 2 for fluid 8, for example water. The ultrasonic fluid meter 1 is intended to be installed in the fluid supply network 2, for example a pipeline system. A connection housing 3 with an inlet 4 and an outlet 5 is provided, the connection housing 3 respectively having a flange 9 on the inlet and outlet sides for connection to further elements of the fluid supply network 2. In an alternative configuration, screw connections or threads or other pipe connections may be provided instead of flanges 9 for connecting to elements of the fluid supply network 2.

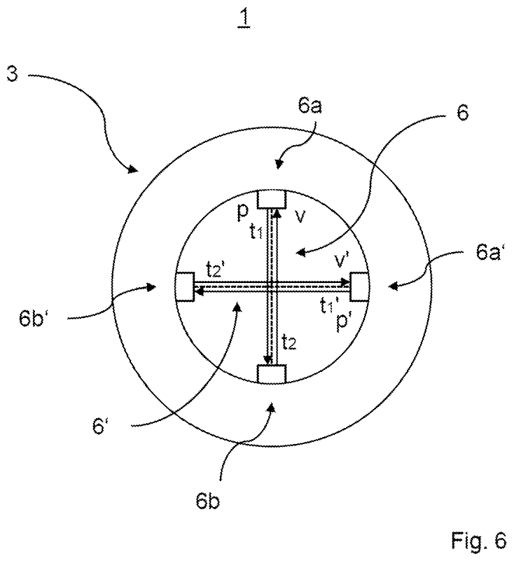

Between the inlet 4 and the outlet 5, there is an ultrasound measurement path 6 having a length L, which may for example be disposed at an angle W with respect to the longitudinal axis of the housing 3. The ultrasound measurement path 6 is formed by a first ultrasound transducer 6a and a diagonally opposite second ultrasound transducer 6b. The ultrasound transducers 6a, 6b are mounted in compartments 3a, 3b of the connection housing 3. Both ultrasound transducers 6a, 6b can respectively transmit an ultrasound signal 10a, 10b and respectively receive an ultrasound signal 10b, 10a transmitted by the other ultrasound transducer 6b, 6a. The transmitted and received ultrasound signals 10a, 10b are recorded and evaluated with the aid of a control and calculation unit 7. In alternative configurations, the control and calculation unit 7 may also forward transmitted and/or received ultrasound signals 10a, 10b wirelessly or through wires to a head end (not represented), the head end being configured to evaluate the transmitted and received ultrasound signals 10a, 10b. A temperature sensor 11 for recording the temperature T of the fluid 8 is furthermore provided on the connection housing 3. Optionally, there may be a second ultrasound measurement path (not represented in FIG. 1), which is formed by an additional ultrasound transducer 6a′ and an ultrasound transducer 6b′ (likewise not represented in FIG. 1) (see FIG. 6).

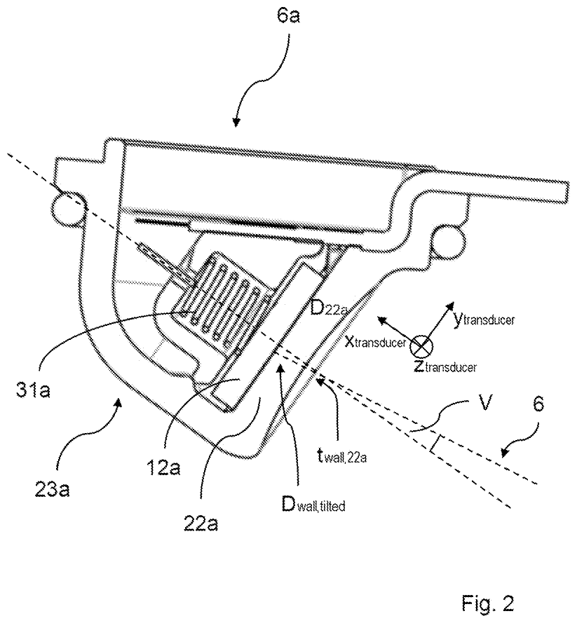

FIG. 2 shows the ultrasound transducer 6a of the ultrasonic meter 1 in an enlarged representation. The ultrasound transducer 6a has a disc-shaped transducer body 12a in the form of a piezo element with contact electrodes (not represented) for generating an ultrasound signal 10a or for recording an ultrasound signal 10b. The transducer body 12a is located in a transducer housing 23a and is pressed by a spring 31a onto the inner side of a wall 22a of the transducer housing 23a so that it bears on the wall 22a, preferably without a gap. The ultrasound signals 10a, 10b pass through the wall 22a, which has a thickness D₂₂ₐ. The transducer housing 23a preferably is formed of plastic. The ultrasound transducer 6b is constructed in the same way and likewise has a transducer body 12b, a spring 31b and a transducer housing 23b having a wall 22b with a thickness D_{22b}.

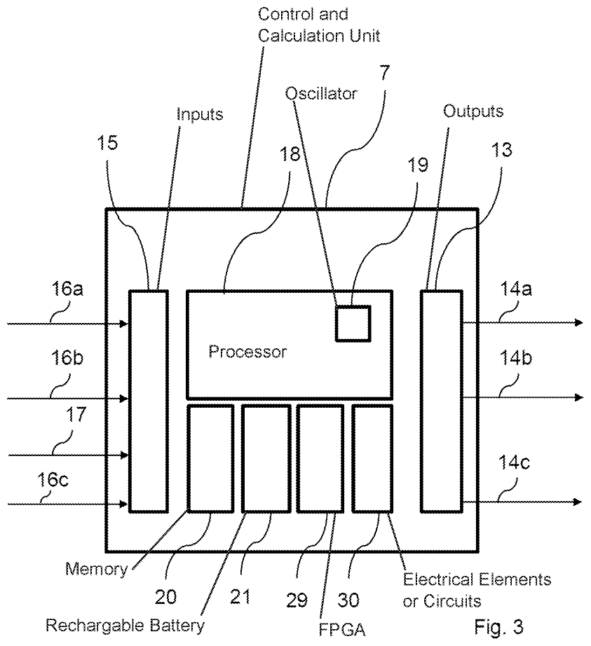

FIG. 3 shows an example of a control and calculation unit 7 of the ultrasonic meter 1, which has outputs 13 for generating transmission signals 14a, 14b in order to generate the respective ultrasound signal 10a, 10b and inputs 15 for recording reception signals 16a, 16b of the respectively received ultrasound signal 10a, 10b and for recording a temperature signal 17 of the temperature sensor 11. In addition, a transmission signal 14c may be transmitted to the head end (not represented) and a reception signal 16c may be received from the head end. A processor 18, for example a microcontroller having an oscillator 19, for example an oscillating crystal, for generating a time reference, is furthermore provided. The control and calculation unit 7 may also have a memory 20, a rechargeable battery 21, an FPGA 29 or other electrical elements or circuits 30, for example communication modules, for the wireless or wired transmission and reception of data, for example wirelessly by using radio protocols or through wires by using an MBus or LBus, time reception modules, for example for DCF77 signals, or positioning modules, for example GPS. The communication module may furthermore be configured to transmit data through the output 13 to the head end and/or receive data therefrom through the input 15. With the aid of signal processing taking place on the processor 18 and/or the FPGA 29 and/or the head end and/or the time reference through the oscillator 19, the instants t_{transmitted} and t_{received} of the transmitted transmission signals 14a,14b and of the received reception signals 16a, 16b may respectively be ascertained and the ultrasound times of flight t₁ and/or t₂ may be measured therefrom and, for example, calculated as follows:

t₁=t_{16a,received}−t_{14a,transmitted}

t₂=t_{16b,received}−t_{14b,transmitted}

The measured ultrasound times of flight t₁, t₂ correspond approximately to the fluid times of flight t_{1,fluid}, t_{2,fluid}, that is to say the ultrasound times of flight through the fluid 8. If the length L and the angle W are known and invariant, the fluid times of flight t_{1,fluid}, t_{2,fluid} may be calculated with the ultrasound speed of the fluid c_{fluid}, for example according to:

$${t}_{1} \approx {t}_{1 , fluid} = \frac{L}{{c}_{fluid} + v \cdot cos ( W )} and$$

$${t}_{2} \approx {t}_{2 , fluid} = \frac{L}{{c}_{fluid} + v \cdot cos ( W )}$$

It is furthermore known to calculate the flow velocity v by taking the difference of the inverses of the measured ultrasound times of flight t₁, t₂, for example as follows:

$$v = \frac{{t}_{2} - {t}_{1}}{{t}_{1} \cdot {t}_{2}} \cdot \frac{L}{2 cos ( W )}$$

the ultrasound speed of the fluid c_{fluid} being eliminated by the difference being taken.

With a known flow velocity v, the ultrasound speed of the fluid c_{fluid} may be calculated (by rearranging the formulae above with c_{fluid} as the subject) by using t₁ or t₂, for example as follows:

$${c}_{fluid} = \frac{L}{{t}_{1}} - v \cdot cos ( W ) or$$

$${c}_{fluid} = \frac{L}{{t}_{2}} - v \cdot cos ( W )$$

Alternatively, the ultrasound speed of the fluid c_{fluid} may be calculated by using the sum of the inverses of the measured ultrasound times of flight t₁, t₂, for example as follows:

$${c}_{fluid} = \frac{L}{2} ( \frac{1}{{t}_{1}} + \frac{1}{{t}_{2}} )$$

in which case the angle W and the flow velocity v may be eliminated.

The ultrasound speed of the fluid c_{fluid} is dependent on the temperature T and the fluid pressure p, a pressure change Δp leading only to a very small change of the ultrasound speed of the fluid Δc_{fluid}. With a known or ascertained ultrasound speed of the fluid c_{fluid} and a known or measured temperature T, the fluid pressure may be determined as a function p=f(c_{fluid}, T). Even small time-of-flight deviations of the measured ultrasound times of flight t₁, t₂ from the fluid times of flight t_{1,fluid}, t_{2,fluid} lead to relatively large deviations in the pressure determination.

During the measurement of the ultrasound times of flight t₁, t₂, however, deviations may occur. Such deviations of the measured ultrasound times of flight t₁ and/or t₂ may be caused by various influences, for example the length L of the ultrasound measurement path 6 or a length change ΔL thereof, an ultrasound time-of-flight component along the ultrasound measurement path 6, which does not lie in the fluid 8, or a change thereof, an ultrasound time-of-flight component within the ultrasound measurement path, which lies in the fluid 8, or a change thereof, a fastening and/or position of the ultrasound transducer with respect to the ultrasound measurement path 6 or a change thereof, a latency of the signal processing or a change thereof and/or a throughput or a change thereof. Whereas these time-of-flight deviations can be compensated partially in the determination of the flow velocity v because of the difference being taken, without further measures the influences however lead to relatively large measurement deviations in the determination of the ultrasound speed of the fluid c_{fluid}, or the pressure determination derived therefrom.

Methods 28 according to the invention for determining the fluid pressure p are therefore applied in the following exemplary embodiments.

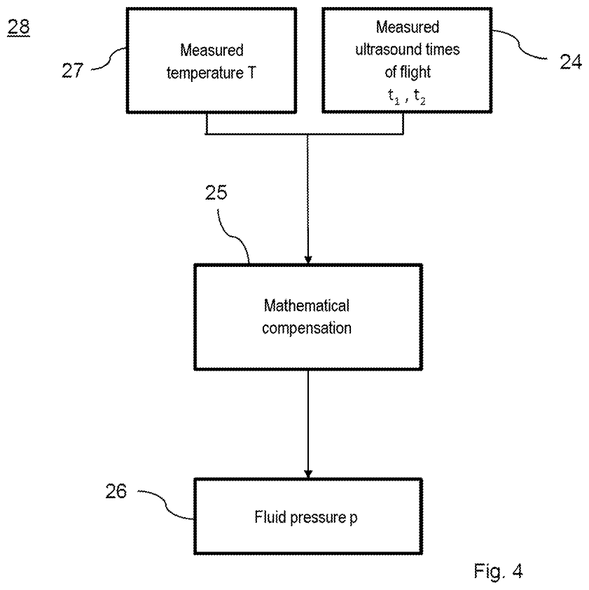

FIG. 4 shows a schematic representation of a method 28 according to the invention. The fluid pressure 26 is ascertained by using a mathematical compensation 25 from a measured ultrasound time of flight 24, t₁ or t₂, or from the measured ultrasound times of flight 24, t₁ and t₂, and a measured temperature 27, the temperature T of the fluid 8.

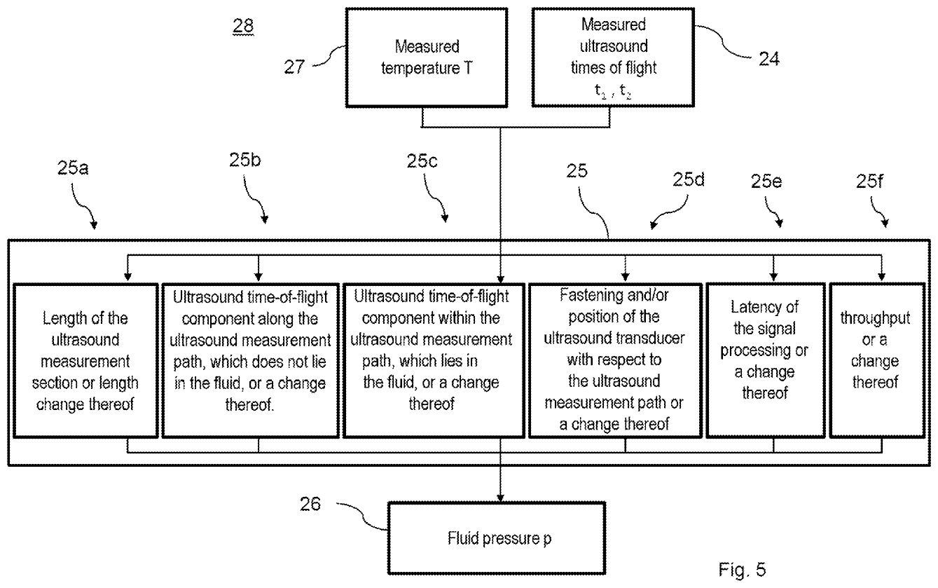

FIG. 5 shows a configuration of the method 28 according to the invention. The method 28 may include a mathematical compensation 25 of one or more influences 25a-25f. The compensation may be based on purely mathematical calculations, that is to say analytical or numerical calculations. The output variable Y of the compensation 25 may in this case be calculated as a function f of the input variables (X₁, X₂, . . . X_{N}) according to Y=f(X₁, X₂, . . . X_{N}). The input variables (X₁, X₂, . . . X_{N}) of the calculations may in this case be based on measurement values, although in particular no reference measurement of the output variables Y is required.

The following formulae should be interpreted in such a way that they may be combined with the formulae above of the ultrasound times of flight t₁ and/or t₂, the time-of-flight differences, or differences of the inverses, and/or the time-of-flight sums, or sums of the inverses.

The control and calculation unit 7 is configured to carry out the calculations of the method 28 and/or to forward the data to a head end, the head end being configured to carry out the method 28 for determining the fluid pressure p. Alternatively or in addition, data may also be transmitted from the head end to the control and calculation unit 7. The data may, for example, be the measured ultrasound times of flight t₁ and/or t₂. Alternatively, the mathematical compensation 25 may also be carried out on the control and calculation unit 7 and/or on the head end, in which case the data may be the results or partial results of the mathematical compensation 25.

Temperature-dependent length or length variation of the ultrasound measurement path 25a:

In a first exemplary embodiment, the time-of-flight deviations due to the length expansion of the housing, and therefore the length change ΔL of the ultrasound measurement path length L may be corrected, in which case the corrected ultrasound measurement path may for example be calculated as follows:

L_{corrected}=L+ΔL

The length change may be caused by thermal expansion, in which case the length L may be a known length at a reference temperature (for example the standard reference temperature T_{ref}=20° C.) and ΔT may be the temperature difference of the housing temperature T_{housing} from the standard reference temperature T_{ref}, and may for example be calculated as follows:

ΔT_{housing}=T_{housing}−T_{ref}

The housing temperature T_{housing} may, with the assumption that the housing has the same temperature as the fluid 8, be the measured temperature T of the fluid 8. Alternatively, however, there may also be other temperature sensors in or on the connection housing 3, which are used to determine the housing temperature T_{housing}.

In one variant of the compensation of the thermal length expansion, with a homogeneous temperature change of the connection housing 3, the length change ΔL may for example be calculated in a simplified fashion as follows with a linear expansion coefficient α_{housing}, which is dependent on the housing material:

ΔL=L·α_{housing}·ΔT_{housing}

Depending on the material of the connection housing 3, a linear expansion coefficient may for example have a value of α_{housing}=10.5·10⁻⁶ K⁻¹ (for example for cast iron). In an alternative configuration, the housing may also include steel, for example stainless steel, or plastic or another material suitable for fluid lines, or a material combination.

In another variant of the correction of the thermal length expansion, one or more nonlinear expansion coefficients (β_{housing}, γ_{housing}, . . . ) may additionally be taken into account in the calculation besides a linear expansion coefficient. A numerical calculation with finite element methods (FEM) may likewise be envisaged, for example in the case of an inhomogeneous heat distribution. For the calculation of the length change, a temperature gradient inside the housing may for example be taken into account in this case, this being for example simulated on the basis of measured temperatures of a plurality of temperature sensors.

Ultrasound time-of-flight component along the ultrasound measurement path, which does not lie in the fluid, or a change thereof 25b:

In another exemplary embodiment, an ultrasound time-of-flight component t_{correction} along the ultrasound measurement path, which does not lie in the fluid, may for example be calculated as follows for compensation or correction of the measured ultrasound times of flight t₁ and/or t₂:

t_{1,fluid,corrected}=t₁−t_{correction}

or

t_{2,fluid,corrected}=t₂−t_{correction}

The ultrasound time-of-flight component t_{correction} may, as shown in FIG. 2, be the ultrasound time-of-flight t_{wall,22a} through the wall 22a of the transducer housing 23a of the ultrasound transducer 6a. With the thickness D₂₂ₐ of the wall and the material-dependent ultrasound speed c_{wall,22a}, the ultrasound time-of-flight component of the wall may, for example, be calculated as follows:

$${t}_{wall , 22 a} = \frac{{D}_{22 a}}{{c}_{wall , 22 a}}$$

If the ultrasound time-of-flight components of the walls of the two ultrasound transducers 6a, 6b are equal, the following may for example apply:

t_{wall}=t_{wall,22a}=t_{wall,22b}

The corrected ultrasound time-of-flight components may then, for example, be calculated as follows:

t_{1,fluid,corrected}=t₁−2·t_{wall}

or

t_{2,fluid,corrected}=t₂−2·t_{wall}

In another variant, the ultrasound time-of-flight components of the walls of the two ultrasound transducers 6a, 6b may also be different, for example because of different thicknesses D₂₂ₐ, D_{22b} and/or different ultrasound speeds c_{wall,22a}, c_{wall,22b}. In this case, the ultrasound times of flight may for example be calculated as follows:

t_{1,fluid,corrected}=t₁−t_{wall,22a}−t_{wall,22b}

or

t_{2,fluid,corrected}=t₂−t_{wall,22a}−t_{wall,22b}

In another exemplary embodiment, thermal expansion of the wall 22a may be calculated in the form of a thickness change ΔD₂₂ₐ of the wall 22a, for example as follows:

ΔD₂₂ₐ=D₂₂ₐ·α_{wall,22a}·ΔT
with the linear expansion coefficient α_{wall,22a} and the thickness D₂₂ₐ, which in this case may be a known or ascertained thickness at a reference temperature (for example the standard reference temperature T_{ref}=20° C.), ΔT being the temperature difference of the wall temperature T_{wall,22a} from the standard reference temperature T_{ref}. Nonlinear expansion coefficients (β_{wall,22a}, γ_{wall,22a}, . . . ) may additionally be taken into account in the calculation, or FEM may be used. The wall temperature T_{wall,22a} may correspond to the temperature T of the fluid 8. It is, however, also conceivable to provide further temperature sensors on the walls. In the same way, for example, a thickness change ΔD_{22b} of the wall 22b may be determined with an expansion coefficient α_{wall,22b} and a wall temperature T_{wall,22b}, or the two thickness changes ΔD₂₂ₐ, ΔD_{22b} may be equal. The thicknesses D₂₂ₐ, D_{22b} and/or the thickness changes ΔD₂₂ₐ, ΔD_{22b} may also lead to a length change ΔL of the ultrasound measurement path and be used for the correction thereof.

In another embodiment, a thermally induced change of the ultrasound speeds Δc_{wall,22a}, Δc_{wall,22b} of the walls 22a, 22b may be taken into account. Alternatively, material differences, for example between different batch numbers during manufacture, may also lead to a change of the ultrasound speeds.

Ultrasound time-of-flight component within the ultrasound measurement path, which lies in the fluid, or a change thereof 25c:

In another embodiment, an ultrasound time-of-flight component within the ultrasound measurement path, which lies in the fluid, or a change thereof 25c may also be compensated. For example, a corrected ultrasound time of flight through the fluid due to a change of the ultrasound speed of the fluid Δc_{fluid} may be calculated as follows:

$${t}_{1 , fluid , corrected} = \frac{L}{( {c}_{fluid} + {Δc}_{fluid} ) + v \cdot cos ( W )} or$$

$${t}_{2 , fluid , corrected} = \frac{L}{( {c}_{fluid} + {Δc}_{fluid} ) + v \cdot cos ( W )}$$

A change of the ultrasound speed Δc_{fluid} is in this case not a change due to a change of the fluid pressure p, but may for example occur because of a change of the composition of the fluid (for example a change of the hardness of water, for example the calcium content of the water).

Alternatively, the fluid itself may also change, for example oil instead of water.

Fastening/position of the ultrasound transducer with respect to the ultrasound measurement path 6 or a change thereof 25d:

In another embodiment, the fastening or the position of an ultrasound transducer 6a, 6b with respect to the ultrasound measurement path 6 or a change thereof 25d may be compensated. An ultrasound transducer is in one example tilted by the angle V with respect to the ultrasound measurement path 6 (see FIG. 2). The length through the walls D_{wall,tilted}, through which the ultrasound signals 10a,10b pass, is in this case greater and may for example be calculated as follows:

$${D}_{wall , tilted} = \frac{D}{cos ( V )}$$

The angle V may be equal or different for the two ultrasound transducers 6a, 6b, and this influence may be calculated in the same way or differently for the two ultrasound transducers with the formulae described above. The thickness D may in this case be the thickness of a wall D₂₂ₐ, D_{22b}. An angle change ΔV from a known tilt V may also occur.

In another example, an ultrasound transducer 6a, 6b is displaced in the direction of the ultrasound measurement path 6 by the position x_{transducer}. The length of the ultrasound measurement path may therefore be calculated as follows, for example:

L_{transducer,Δx displaced}=L−x_{transducer}

The length L may in this case be the length of the ultrasound measurement path with unundisplaced ultrasound transducer 6a, 6b, or the nominal length L. Both ultrasound transducers 6a, 6b may also be displaced, the effect of the displacements being partially cancelled when the two ultrasound transducers 6a, 6b are displaced in the same direction and the effect being amplified when the displacements take place in opposite directions.

The position of one or both ultrasound transducers may also be displaced transversely with respect to the ultrasound measurement path with y_{transducer}, so that the angle W and the length L change. The angle change ΔW may in this case be calculated as follows, for example:

$$ΔW = arcsin ( \frac{{Δy}_{transducer}}{L} )$$

The length change ΔL may, for example, be calculated with:

ΔL_{transducer,y displaced}=\sqrt{y_{transducer}²+L²}
where L may be the nominal length or a measured length of the ultrasound measurement path without displacement. In the event of a displacement z_{transducer}, the length may for example be calculated in the same way as for a displacement y_{transducer}, in which case the angle W may remain the same. Position changes Δx_{transducer}, Δy_{transducer}, Δz_{transducer} in relation to known position deviations x_{transducer}, y_{transducer}, z_{transducer} may also be taken into account.

The deviations of the position of the ultrasound transducers 6a, 6b with respect to the ultrasound measurement path occur, for example, as a result of the mounting in the compartments 3a, 3b or a manufacturing tolerance of the compartments 3a, 3b.

Alternatively, a length change, in particular of the surface of the wall 22a, 22b of the ultrasound transducer housing 23a, 23b that faces towards the fluid, may be corrected. The position change may for example be caused by a thermal expansion of the wall 22a, 22b and/or of the ultrasound transducer housing 23a, 23b, and may be corrected as already described.

Latency of the signal processing or a change thereof 25e:

In another embodiment, the ultrasound time of flight t₁ and/or t₂ may also be compensated by a latency component of the electronics t_{latency}. The latency component may, for example, be subtracted from the measured ultrasound times of flight t₁ and/or t₂. The latency component results, for example, from the time offset between the respective transmission signal 14a,14b and the respectively transmitted ultrasound signal 10a, 10b and/or the time offset between the respective reception signal 16a, 16b and the respectively received ultrasound signal 10a, 10b. Further effects may be the signal processing when ascertaining the ultrasound times of flight t₁ and/or t₂, time-of-flight differences and/or time-of-flight sums and/or differences of the inverses and/or sums of the inverses. In the case of signal processing on the FPGA 29, the latency component may for example be constant, whereas the latency component for signal processing on the processor 18, for example a microcontroller, may be variable and may be ascertained individually for each calculation. Division of the signal processing between the FPGA 29 with a fixed latency component and the processor 18 with a variable latency component is also conceivable, in which case the total latency may be the sum of the two latency components. In the case of signal processing on a head end, latencies may also occur because of the transmission to the head end and may be compensated.

Throughput or a change thereof 25 f:

In an alternative configuration, the measured ultrasound times of flight t₁ and/or t₂ may be corrected because of the throughput with the time-of-flight component t_{throughput}, which is caused by the throughput. The corrected times of flight t_{1,throughput,corrected}, t_{2,throughput,corrected} may in this case be calculated as follows, for example:

t_{1,throughput,corrected}=t₁−t_{throughput}

or

t_{2,throughput,corrected}=t₂+t_{throughput}

The times of flight corrected by the throughput t_{1,throughput,corrected}, t_{2,throughput,corrected} may be used individually in order to ascertain the fluid pressure p. Alternatively, the corrected times of flight t_{1,throughput,corrected}, t_{2,throughput,corrected} may also be combined with one another and/or with the other described mathematical compensations 25.

In a further alternative configuration, with a known geometry, the flow velocity v may also be determined or derived from the throughput or from a quantity proportional to the flow velocity v.

In another configuration, the average value tₐᵥ may be formed from the measured ultrasound times of flight t₁ and t₂, with:

$${t}_{M} = \frac{{t}_{1} + {t}_{2}}{2}$$

Under the assumption that the time-of-flight components caused by the throughput are equal in magnitude, it is possible to calculate an average time-of-flight tₐᵥ which is independent of the throughput or the flow velocity v or of a quantity proportional to the flow velocity v, for example as follows:

$${t}_{M} = \frac{L}{{c}_{fluid}}$$

The ultrasound speed of the fluid c_{fluid} may therefore be calculated, for example, as follows:

$${c}_{fluid} = \frac{L}{{t}_{m}}$$

Exemplary embodiments of the pressure determination with a characteristic diagram or look-up table:

In another exemplary embodiment, the fluid pressure p_{E} is initially ascertained on the basis of a characteristic diagram or a look-up table, for example with the input variables of the measured ultrasound times of flight t₁ and/or t₂ and/or the temperature T and/or the flow velocity v or a quantity proportional to the flow velocity v, for example the throughput. The determination of the fluid pressure p_{E} may in this case, for example, be carried out in a first step by reference measurements. In a second step, the fluid pressure p_{E} may be used as an input variable for the mathematical compensation 25 in order to determine the fluid pressure p.

Further exemplary embodiment of a fluid meter having a multiplicity of ultrasound measurement paths:

FIG. 6 shows a cross section of an ultrasonic fluid meter 1, in which an ultrasound measurement path 6′ that is formed by the ultrasound transducers 6a′, 6b′ may be provided besides the ultrasound measurement path 6 that is formed by the ultrasound transducers 6a, 6b. Besides the measured ultrasound times of flight t₁, t₂ of the first ultrasound measurement path 6, the ultrasound times of flight t₁′, t₂′ of the second ultrasound measurement path 6′ may be measured by the control and calculation unit 7 or the head end. One or more mathematical compensations 25 may be applied to individual, several or all measured ultrasound times of flight t₁, t₂, t₁′, t₂′. In addition, an average value of the measured ultrasound times of flight t₁, t₂, t₁′, t₂′ and/or of the pressures p, p′ calculated with the method 28 and/or of the flow velocities v, v′ and/or of the quantities proportional to the flow velocities v, v′, for example the throughputs, of the ultrasound measurement paths 6, 6′ may be determined. The ultrasound measurement paths 6, 6′ are preferably disposed at a right angle to one another in relation to the cross section of the housing 3. In other embodiments, the ultrasound measurement paths may be disposed at a different angle or opposite (180° to one another). FIG. 6 shows two ultrasound measurement paths 6, 6′ respectively having two ultrasound transducers 6a, 6b, 6a′, 6b′, although it is also possible to provide a multiplicity of ultrasound measurement paths 6, 6′, . . . , 6ⁿ, each having two ultrasound transducers 6a, 6b, 6a′, 6b′, . . . , 6aⁿ, 6bⁿ, in which case a weighted average value may likewise be formed from the multiplicity of measured ultrasound times of flight t₁, t₂, t₁′, t₂′, . . . , t₁ⁿ, t₂ⁿ and/or fluid pressures p, p′, . . . , pⁿ and/or flow velocities v, v′, . . . , vⁿ and/or the quantities proportional to the flow velocities v, v′, . . . , vⁿ, for example the throughputs.

The ultrasound transducers 6b, 6a′, 6b′, . . . 6aⁿ, 6bⁿ may have the same elements and the same arrangement as the ultrasound transducer 6a represented in FIG. 2.

In a further alternative configuration, the ultrasound measurement path may also contain at least one deviation caused by a reflector. For example, the ultrasound measurement path may be configured in a U-shape by a double deviation taking place because of two reflectors. The ultrasound measurement path may in this case, for example, extend transversely with respect to the axis of the connection housing through the fluid starting from the first ultrasound transducer and be deviated parallel to the axis of the connection housing by a first reflector. Furthermore, a deviation may take place because of a second reflector, so that the ultrasound measurement path extends transversely with respect to the axis of the connection housing as far as the second ultrasound transducer.

In another configuration, the ultrasound measurement path may also extend at an angle with respect to the axis of the connection housing from the first ultrasound transducer to a reflector, and from the reflector at an angle to the second ultrasound transducer, that is to say for example with a V-shaped deviation. Alternatively, a plurality of deviations may take place by using a multiplicity of reflectors, respectively at an angle with respect to the axis of the connection housing, that is to say for example with a W-shaped deviation.

The present invention may be used both in bulk water meters and in household water meters. Depending on the application, the described mathematical compensations 25 need to be adapted accordingly for the alternative geometries and/or ultrasound measurement path arrangements.

According to the invention, the mathematical compensations 25 of the exemplary embodiments may be used individually, although several mathematical compensations 25 of one or more influences 25a-25f may also be applied successively and/or simultaneously and/or may be combined.

Partial combinations or subcombinations of features are also explicitly included by the disclosure content of the invention.

The following is a summary list of reference numerals and the corresponding structure used in the above description of the invention.

### LIST OF REFERENCES

1 ultrasonic fluid meter
2 fluid supply network
3 connection housing
3a compartment
3b compartment
4 inlet
5 outlet
6 ultrasound measurement path
6′ ultrasound measurement path
6a first ultrasound transducer
6b second ultrasound transducer
6a′ ultrasound transducer
6b′ ultrasound transducer
7 control and calculation unit
8 fluid
9 flange
10a first ultrasound signal
10b second ultrasound signal
11 temperature sensor
12a piezo
13 outputs
14a transmission signals of the first ultrasound signal
14b transmission signals of the second ultrasound signal
14c transmission signal
15 inputs
16a reception signals of the first ultrasound signal
16b reception signals of the second ultrasound signal
16c reception signal
17 temperature signal
18 processor
19 oscillator
20 memory
21 rechargeable battery
22a wall
23a ultrasound transducer housing
24 measured ultrasound times of flight
25 mathematical compensation
25a influence
25b influence
25c influence
25d influence
25e influence
25f influence
26 compensated pressure
27 measured temperature
28 method
29 FPGA
30 electrical circuits
31a spring
D₂₂ₐ thickness of a wall
p fluid pressure
p′ fluid pressure
p_{E} fluid pressure
T temperature
t₁ measured ultrasound time of flight
t₂ measured ultrasound time of flight
t^{1′ measured ultrasound time of flight}
t₂′ measured ultrasound time of flight
t_{1,fluid} fluid time of flight
t_{2,fluid} fluid time of flight
t_{wall,22a} time of flight through wall
V angle of an ultrasound transducer
v flow velocity
v′ flow velocity
W angle of an ultrasound measurement path
x_{transducer} position of an ultrasound transducer
y_{transducer} position of an ultrasound transducer
z_{transducer} position of an ultrasound transducer

1. A method for ascertaining a fluid pressure in a fluid supply network for fluid, the method comprising:
providing a first ultrasound transducer and a second ultrasound transducer;
using at least one of the ultrasound transducers to emit at least one ultrasound signal, and measuring at least one ultrasound time of flight of the ultrasound signal in the fluid along an ultrasound measurement path;
determining a flow velocity or a quantity proportional to the flow velocity or a throughput from the at least one measured ultrasound time of flight;
determining the fluid pressure from the at least one measured ultrasound time of flight aided by a mathematical compensation;
relating the mathematical compensation to at least one influence selected from a following group of influences:
a length of the ultrasound measurement path or a length change of the ultrasound measurement path; or
an ultrasound time-of-flight component along the ultrasound measurement path not lying in the fluid or a change of the ultrasound time-of-flight component along the ultrasound measurement path not lying in the fluid; or
an ultrasound time-of-flight component within the ultrasound measurement path lying in the fluid or a change of the ultrasound time-of-flight component within the ultrasound measurement path lying in the fluid; or
at least one of a fastening or position of the ultrasound transducer relative to the ultrasound measurement path or a change of the at least one fastening or position of the ultrasound transducer relative to the ultrasound measurement path; or
a latency of signal processing or a change of the signal processing; or
the throughput or a change of the throughput.

2. The method according to claim 1, which further comprises:
emitting an ultrasound signal by the first ultrasound transducer, receiving the ultrasound signal by the second ultrasound transducer, and measuring the ultrasound time of flight;
emitting an ultrasound signal by the second ultrasound transducer, receiving the ultrasound signal by the first ultrasound transducer, and measuring the ultrasound time of flight;
determining the flow velocity or a quantity proportional to the flow velocity or the throughput from at least one of the measured ultrasound times of flight or a difference of the measured ultrasound times of flight or a difference of inverses of the measured ultrasound times of flight.

3. The method according to claim 2, which further comprises ascertaining the fluid pressure aided by the mathematical compensation from at least one of:
the measured ultrasound times of flight, or
a time-of-flight difference of the measured ultrasound times of flight, or
a difference of the inverses of the measured ultrasound times of flight, or
a time-of-flight sum of the measured ultrasound times of flight, or
a sum of the inverses of the measured ultrasound times of flight, or
an average value of the measured ultrasound times of flight.

4. The method according to claim 1, which further comprises at least one of orienting the ultrasound measurement path obliquely at an angle relative to a flow direction of the fluid or deviating the ultrasound measurement path one or more times by using reflectors.

5. The method according to claim 1, which further comprises measuring or determining and using a temperature or a temperature change or a temperature change of the temperature from a reference temperature, for the mathematical compensation.

6. The method according to claim 5, which further comprises at least one of using the temperature of the fluid as the temperature or using the temperature change of the fluid as the temperature change.

7. The method according to claim 1, which further comprises providing at least one of:
a connection housing having compartments for the ultrasound transducers, or
a respective ultrasound transducer housing for each of the ultrasound transducers each having a respective wall with a thickness through which at least one ultrasound signal passes.

8. The method according to claim 1, which further comprises carrying out the mathematical compensation exclusively based on mathematical calculations.

9. The method according to claim 1, which further comprises providing the mathematical compensation with at least one input variable X₁, X₂, . . . X_{N} and at least one output variable Y, the at least one output variable Y being calculated aided by a function f from the at least one input variable X₁, X₂, . . . X_{N} according to Y=f (X₁, X₂, . . . X_{N}).

10. The method according to claim 9, which further comprises calculating the at least one output variable Y of the mathematical compensation independently of at least one of reference measurements or characteristic diagram determinations.

11. The method according to claim 9, which further comprises basing the at least one input variable X₁, X₂, . . . X_{N} on at least one of a characteristic diagram or a characteristic curve or a measurement value or empirical data or a comparative measurement or a calibration.

12. The method according to claim 9, which further comprises basing the at least one output variable Y on at least one of at least one geometrical relationship or at least one trigonometric relationship or at least one linear relationship or at least one nonlinear relationship or at least one material constant or at least one physical constant or at least one algorithm or at least one analytical or numerical calculation or at least one numerical simulation.

13. The method according to claim 7, which further comprises relating the mathematical compensation to at least one effect selected from a following group of effects:
a thickness of at least one wall, or
a thickness change of at least one wall, or
an ultrasound speed of at least one wall, or
an ultrasound speed change of at least one wall, or
an ultrasound speed of the fluid, or
an ultrasound speed change of the fluid, or
the flow velocity, or
a length or length change of the ultrasound measurement path due to a thermal expansion or a thermal expansion of the connection housing, based on a temperature or a temperature change, or the temperature or the temperature change of the connection housing corresponding to the temperature or the temperature change of the fluid, or
a tilt of an ultrasound transducer by an angle relative to the ultrasound measurement path, or
an angle change of the angle, or
a position of at least one ultrasound transducer in a direction of the ultrasound measurement path, or
a position change of at least one ultrasound transducer in the direction of the ultrasound measurement path, or
a position of at least one ultrasound transducer transversely relative to the ultrasound measurement path and along a plane formed by the ultrasound measurement path and an axis of the connection housing, or
a position change of at least one ultrasound transducer transversely relative to the ultrasound measurement path and along a plane formed by the ultrasound measurement path and the axis of the connection housing, or
a position of at least one ultrasound transducer transversely relative to the ultrasound measurement path and transversely relative to the axis of the connection housing, or
a position change of at least one ultrasound transducer transversely relative to the ultrasound measurement path and transversely relative to the axis of the connection housing, or
a time-of-flight component due to the throughput, or
a time-of-flight component change due to the throughput.

14. The method according to claim 1, which further comprises compensating the latency of the signal processing or a change of the latency of the signal processing by taking a difference of at least one measured ultrasound time of flight and at least one latency component.

15. The method according to claim 14, which further comprises determining the at least one latency component from at least one of a time offset between the at least one transmission signal and the at least one transmitted ultrasound signal or a time offset between the at least one reception signal and the at least one received ultrasound signal.

16. The method according to claim 13, which further comprises determining at least one of the length of the ultrasound measurement path or the length change of the ultrasound measurement path or the angle or the angle change of the ultrasound measurement path based on at least one of a position or a position change or the angle or the angle change of one of the ultrasound transducers.

17. The method according to claim 9, which further comprises ascertaining a fluid pressure from at least one of a look-up table or a characteristic diagram or a reference measurement or a calibration, and using the ascertained fluid pressure as the at least one input variable X₁, X₂, . . . X_{N} for the determination of the fluid pressure.

18. An ultrasonic fluid meter for installation in a fluid supply network, the ultrasonic fluid meter comprising:
a connection housing with an inlet and an outlet;
at least one ultrasound measurement path provided in said connection housing for measuring along said at least one ultrasound measurement path at least one ultrasound time of flight of an ultrasound signal propagating along said ultrasound measurement path in a fluid;
at least a first and a second ultrasound transducer, each of said first or second ultrasound transducers respectively receiving or emitting the ultrasound signal propagating along said ultrasound measurement path; and
a control and calculation unit configured to at least one of carry out the method for determining the fluid pressure according to claim 1 or forward data or the measured ultrasound time of flight to a head end configured to carry out the method for determining the fluid pressure according to claim 1.

19. The ultrasonic fluid meter according to claim 18, wherein said ultrasound measurement path is disposed at an angle or an acute angle relative to an axis of said connection housing.

20. The ultrasonic fluid meter according to claim 18, which further comprises a temperature sensor for recording a temperature of the fluid.

21. The ultrasonic fluid meter according to claim 18, wherein said ultrasound transducers are mounted in compartments in said connection housing.

22. The ultrasonic fluid meter according to claim 18, wherein said at least one ultrasound measurement path is one of a multiplicity of ultrasound measurement paths for determining at least one of a multiplicity of measured ultrasound times of flight or pressures or flow velocities or quantities proportional to the flow velocities or throughputs.

23. The ultrasonic fluid meter according to claim 22, wherein said multiplicity of ultrasound measurement paths intersect each other and are disposed at an angle relative to a cross section of said connection housing.

24. The ultrasonic fluid meter according to claim 23, wherein said control and calculation unit is configured to carry out a centerweighted determination of at least one of the pressures or the flow velocities or the quantities proportional to the flow velocities or the throughputs.

25. The ultrasonic fluid meter according to claim 22, wherein said control and calculation unit is configured to determine at least one of a weighted average value or equally weighted average value of the measured ultrasound times of flight or a weighted average value or equally weighted average value of the pressures or a weighted average value or equally weighted average value of the flow velocities or of the quantities proportional to the flow velocities or the throughputs.
